(19) United States
(12) Patent Application Publication
(10) Pub. No.: US 2005/0004714 A1
(43) Pub. Date: Jan. 6, 2005

(54) Deodorizer control device for spraying system

(76) Inventor: Cheng-Fong Chen, Taipei (TW)

Correspondence Address: Cheng-Fong Chen, 235 Chung - Ho, Box 8-24, Taipei, TW

(21) Appl. No.: 10/611,694

(22) Filed: Jul. 2, 2003

(51) Int. Cl. G05D 7/00; G05B 11/01

(52) U.S. Cl. 700/283; 700/17

(57) ABSTRACT

A deodorizer control device for spraying system includes a central processing unit. A central processing unit is defined with at least one operation mode. A liquid crystal display panel is connected to the central processing unit for selecting an operation mode from the at least one operation mode and displaying a working state of the selected operation mode. The liquid crystal display panel has functions of displaying time period of operation, date, time, dose used, external power source, and insufficiency of the date, time, dose, power; a spraying can is operated under the selected operation mode so as to control the spraying amount with a predetermined value.

### BACKGROUND OF THE INVENTION

The present invention relates to spraying system, and particularly to a deodorizer control device for spraying system which provides a plurality of spraying modes so that the user can well control a spraying process.

In general, stool is placed with detergent agents which can be resolved in the water of the stool. In general the dose of the detergent agent is uncontrollable so that it is often that too much amount of the agent is used so that the agent is used up quickly. Thereby, the user must to supply a new one. Not only it is waste, but also it induces the labor waste.

In general, spray device sprays spraying agent, such as aromatics, deodorant sprays or pesticides, etc. with only one operation mode so that the dose and spraying amount can not be well controlled. As a consequence the spraying agent is wasted.

Thereby, there is an eager demand for a novel device which can provide a well controlled spraying amount so that the spraying agent is saved.

Accordingly, the primary object of the present invention is to provide a deodorizer control device for spraying system, wherein central processing unit is defined with at least one operation mode. A liquid crystal display panel is connected to the central processing unit for selecting an operation mode from the at least one operation mode and displaying a working state of the selected operation mode. The liquid crystal display panel has functions of displaying time period for operation, date, time, dose used, external power source, and insufficiency of the date, time, dose, power; a spraying can is operated under the selected operation mode so as to control the spraying amount with a predetermined value.

The various objects and advantages of the present invention will be more readily understood from the following detailed description when read in conjunction with the appended drawing.

### BRIEF DESCRIPTION OF THE DRAWINGS

FIG. 1 is a block diagram of the present invention.

FIG. 2 shows the central processing unit and external control and detecting unit of the present invention.

FIG. 3 shows a block diagram about the detecting unit of the present invention.

### BRIEF DESCRIPTION OF THE PREFERRED EMBODIMENTS

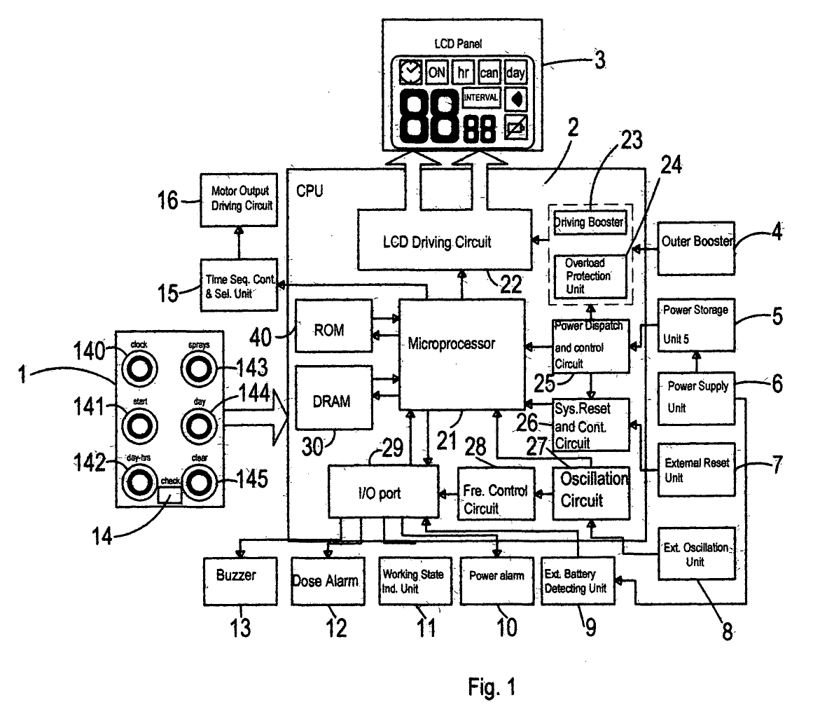

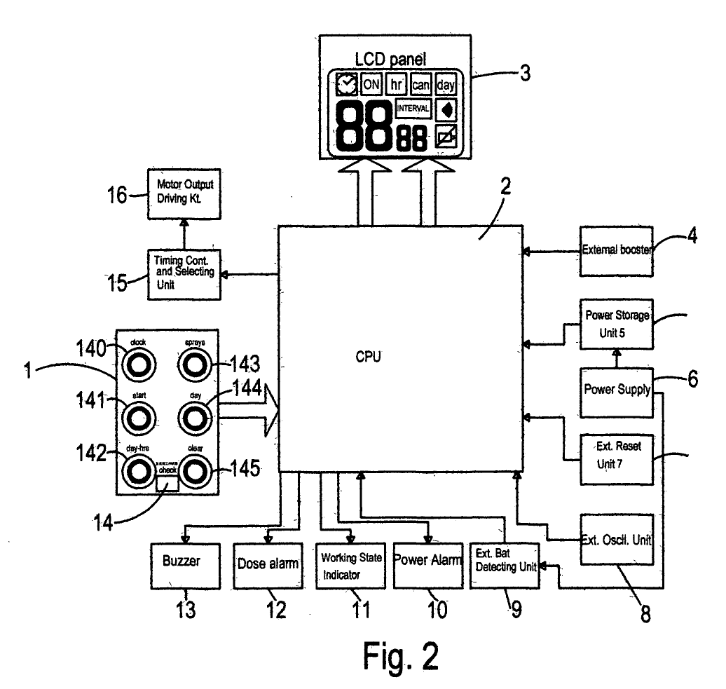

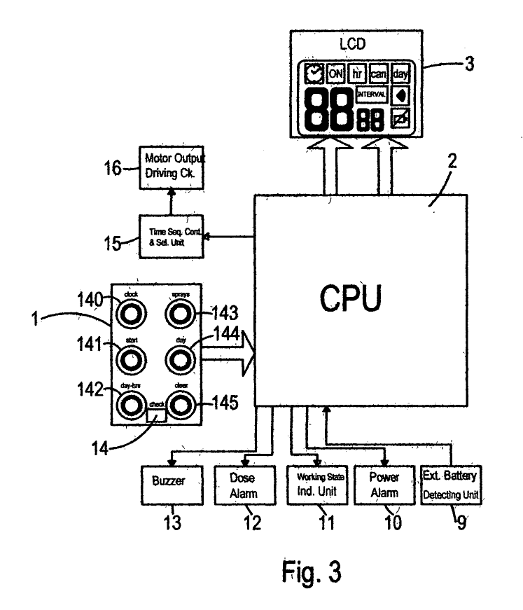

Referring to FIGS. 1, 2 and 3, the deodorizer control device for spraying system of the present invention is illustrated for controlling the supply dose of an agent. The spray may be aromatics, deodorant sprays or pesticides, etc. The deodorizer control device for spraying system of the present invention has a main control kernel. The main control kernel comprises a central processing unit 2, and an external control and detecting unit. The external control and detecting unit includes a liquid crystal display panel 3, external booster 4, a power storage unit 5, a power supply 6, an external reset unit 7, an external oscillating unit 8, an external battery detecting unit 9, a power alarm 10, a working state indicator 11, a dose alarm 12, a keyboard input unit 14, a time sequence control and selecting unit 15, and a motor output driving circuit 16. The central processing unit 2 is an integrated circuit formed by a microprocessor 21, a liquid display driving circuit 22, a driving booster 23, an overload protection circuit 24, a power dispatch circuit 25, a system reset control circuit 26, an oscillator circuit 27, a frequency control circuit 28, a ready only memory 40, a dynamic random accessing memory 30 and an I/O port 29.

The power supply 6 is electrically connected to the power dispatch circuit of the power storage-unit 5 and the central processing unit 2. The power supply 6 is connected to the external battery detecting unit 9. The power supply 6 supplies a voltage to the central processing unit 2. Thereby, when the voltage of the power supply 6 is insufficient, the central processing unit 2 will send a lower voltage signal to a power alarm 10. Meanwhile, the central processing unit 2 sends a lower voltage signal to a buzzer 13 so as to emit alarm voices to inform low voltage occurs. The power of the power supply 6 may be from a battery set or from an external power source through conductive wires.

The external booster 4 is electrically connected to the driving booster 23 and the overload protection circuit 24 of the central processing unit 2 so as to provide a necessary voltage and overload protection to the liquid display driving circuit 22.

The external oscillating unit 8 is electrically connected to the external oscillating circuit 27 of the central processing unit 2 so as to provide a frequency to the central processing unit 2. The external reset unit 7 is electrically connected to the system reset control circuit 26 of the central processing unit 2 for resetting the system.

The time sequence control and selecting unit 15 is electrically connected to the microprocessor 21 of the central processing unit 2 and receives the clock of driving control signal from the microprocessor 21 (the driving signal may be retained through one second, two seconds, or three seconds, etc.)

An output end of the motor output driving unit 16 may be connected to a motor (not shown) for driving the spray agent in the driving spray can.

The liquid crystal display panel 3 is electrically connected to the liquid display driving circuit 22 of the central processing unit 2 for displaying time period for operation, date, time, dose rate and power.

The keyboard input unit 1 is electrically connected to the I/O port 29 of the central processing unit 2 so as to form a selectable operation mode. The keyboard input unit 1 includes a clock 140 and start time 141, days 144, clear 143, and check 14. The indicating marks on the liquid crystal display panel 3 have a plurality of liquid crystal words for displaying the current working states, the operation mode of the keyboard input unit 1, which comprises the following steps:
(1) Press the clock 140 for adjusting the display of time to be 12 hour display or 24 hour display, each time the clock 140 is pressed, it has a time increment of 10 minutes.
(2) Pressing the starting key 141 for adjusting the start time every day; each time the key 141 is pressed, it has a time increment of 1 hour.
(3) Pressing a day-hrs key 142 for selecting time period for working, for example, if the time period is 8 hours, each time the day-hrs is pressed, the words displayed on the liquid crystal display is 08.
(4) Press a spray key 143. In this step, the times of spray is actuated, which may be one of 2000, 2500, 3000, 3400, 6000, 9000.
(5) Press the day key 144. The working day to be selected may be one of 15, 30, 45, 60, 75, 90.
(6) Press the clear key 145. The times of spray and days of use are cleared.
(7) Press a check key for checking the original set day.

Above input value is distributed automatically by the central processing unit 2 in a set period.

When the accumulated times of the driving control signals sent by the central processing unit 2 is equal to that of the default spraying times, the CPU 2 sends a dose insufficiency signal to the liquid display driving circuit 22 to flash a symbol of the liquid display panel 3 to inform the use to supplement or update spraying agent.

When the power supply 6 is lack of power, the CPU 2 will send a power insufficiency signal to the liquid display driving circuit 22 so that the symbol of the power insufficiency on the liquid crystal display panel flashes to inform the user to update the power supply 6.

It is preferably, the power supply 6 can be connected to an AC current through a transformer so as to provide a preferred voltage stability.

The advantage of the present invention will be described in the following:
1. The spraying amount can be programmed.
2. The alarm and display functions are provided.
3. Power alarm is provided.
4. The settings are retained as the battery is updated.
5. The cost about the spraying agent is reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A deodorizer control device for spraying system, characterized in that: the deodorizer control device having a central processing unit; the central processing unit is defined with at least one operation mode; a liquid crystal display panel connected to the central processing unit for selecting an operation mode from the at least one operation mode and displaying a working state of the selected operation mode; the liquid crystal display panel having functions of displaying time period of operation, date, time, dose used, external power source, and insufficiency of the date, time, dose, power; a spraying can connected to the deodorizer control device is operated under the selected operation mode so as to control the spraying amount with a predetermined value.

2. The deodorizer control device for spraying system as claimed in claim 1, wherein a time sequence control and selecting unit is connected to a microprocessor in the central processing unit for receiving a time length of a driving control signal sent by the microprocessor.

3. The deodorizer control device for spraying system as claimed in claim 1, wherein the keyboard input unit is electrically connected to an I/O port of the central processing unit so as to form a selectable operation mode; the keyboard input unit includes a clock key, a start key, a day-hrs key, a spray key, a day key, and a check key.

4. The deodorizer control device for spraying system as claimed in claim 1, wherein the central processing unit records the times of a driving control signal and then compares the times of the driving control signal with a preset value, it the two are equal, then a dose alarm is displayed.

5. The deodorizer control device for spraying system as claimed in claim 1, wherein the central processing unit drives indications on the liquid crystal display panel to light up an indication to present the working state, the selected operation mode, the set work period to inform the user to update or supplement the spraying agent.

6. The deodorizer control device for spraying system as claimed in claim 1, wherein when a battery of the power supply is updated, original settings in the central processing unit is retained.
